(19) United States
(12) Patent Application Publication
(10) Pub. No.: US 2024/0246154 A1
(43) Pub. Date: Jul. 25, 2024

(54) PRINT HEAD FOR 3D PRINTING OF METALS

(71) Applicant: Robert Bosch GmbH, Stuttgart (DE)

(72) Inventors: Benjamin Schweizer, Horb (DE); Eberhard Maier, Koengen (DE)

(21) Appl. No.: 18/566,224

(22) PCT Filed: Jun. 9, 2021
(86) PCT No.: PCT/EP2021/065438

§ 371 Date: Dec. 1, 2023

(51) Int. Cl. B22F 12/53; B22F 10/22; B33Y 10/00; B33Y 30/00

(52) U.S. Cl. CPC B22F 12/53; B22F 10/22; B33Y 10/00; B33Y 30/00; B22F 2998/10

(57) ABSTRACT

The invention relates to a print head (1) for a 3D printer, in particular a metal printer, comprising a housing (3), a device (28) for feeding a metal (14), a piston (5), a reservoir (7, 27) with an outlet opening (10), and an actuator device (12) for displacing the piston (5), wherein the reservoir (7, 27) has a melting region (20) and a displacement body chamber (21) for a liquid phase (8) of the metal (14), wherein the melting region (20) adjoins an inert atmosphere (22) and is connected to the displacement body chamber (21) such that, as a result of the displacement of the piston (5), the liquid phase (8) of the metal (14) can be caused to pass through the outlet opening (10), said housing (3) having a multi-part design and comprising at least one cooling flange (25), an insulating plate (26), and the reservoir (7, 27).

The invention is characterized in that the print head (1) comprises a displacement unit (40) for inserting the piston (5) into the reservoir (7, 27) and retracting it therefrom, the displacement unit (40) comprising a locking element (50).

The invention also relates to a method of operating and/or starting up a print head (1).

### BACKGROUND

The invention relates to a print head for a 3D printing suitable for the printing of metals and a method for operating and/or starting up a print head.

A 3D printer for a thermoplastic material receives a solid phase of said material as the starting material, generates a liquid phase therefrom, and selectively brings this liquid phase to the points associated with the object to be produced. Such a 3D printer comprises a print head into which the starting material is melted. Furthermore, means are provided for generating a relative movement between the print head and the work surface on which the object is to be created. Either the print head only, the work surface only, or both the print head and the work surface can be moved.

The print head has a first operating state in which liquid material exits from it and a second operating state in which no liquid material exits from it. For example, the second operating state is assumed when another position on the work surface is approached and no material is to be deposited on the way. For example, switching can be done between the two operating states of the print head, in that the forward drive of the solid starting material can be switched on or off.

Compared to thermoplastics, metals have a much higher melting point and at the same time have a much lower viscosity in the liquid state.

3D metal printers, in particular drop-on-demand printers, such as those disclosed in the application DE 10 2016 224 047 A1, are of interest for industrial applications but must fulfill the following requirements, among others:
ensuring a long-lasting operation,
reproducibility of the droplets or the construction of the component,
energy efficiency in terms of melting and component design,
maintaining low idling times, e.g. upon starting up and shutting down, and
exchange of wearing parts.

It can be problematic if a piston of the print head remains in the melt or in the region of a nozzle of the print head during the solidification and the remelting. This can cause the melt to expand at points between the piston and the print head that cause uneven stresses to occur on the print head components, which can damage them, or in the worst case scenario could destroy them.

The problem addressed by the invention is to provide a print head that withstands damage caused by melting and solidification of the melt.

### SUMMARY

The problem is solved by the print head according to the disclosure, and the method for operating and/or starting up the print head.

The print head according to the invention for a 3D printer, in particular a metal printer, comprises a housing, a device for feeding a metal, a piston, a reservoir with an outlet opening, and an actuator device for displacing the piston, wherein the reservoir has a melting region and a displacement body chamber for a liquid phase of the metal, wherein the melting region adjoins an inert atmosphere and is connected to the displacement body chamber such that, as a result of the displacement of the piston, the liquid phase of the metal can be caused to pass through the outlet opening. Furthermore, the housing is formed in multiple parts, wherein it comprises at least one cooling flange, an insulating plate, and the reservoir.

According to the invention, the print head comprises a displacement unit for inserting and retracting the piston in and out of the reservoir, wherein the displacement unit comprises a locking element.

In a further development, the locking element comprises an activation device having a latching mechanism.

In a further development, the activation device has a pneumatic design. In alternative configurations, the activation device can also be mechanically, hydraulically electrically, or electromagnetically configured.

In a further advantageous configuration, a final shape between the activation device and a sleeve surrounding the actuator device can be designed in a force-fit and/or form-fit manner. The force-fit can be effected, for example, by surface friction, and the form-fit can be effected, for example, by a groove-and-mandrel.

The displacement unit is advantageously installed in the print head and performs the function of a piston lifting function. Only when the printing material is melted, the punch is driven into the liquid metal. After the printing process has been completed, the punch is retracted out of the reservoir or the crucible. Only then can the material solidify.

In an advantageous configuration of the method according to the invention, after the filling of the reservoir with melt, the locking element is first released and the actuator is moved axially. The movement of the tip of the piston facing the outlet opening in a direction of movement away from the outlet opening is slower than the movement of the tip of the piston facing the outlet opening in a direction of movement towards the outlet opening. After a plurality of repetitions of the movements to promote a wetting of the outlet opening with melt, the actuator is again locked in an axial position with the locking element.

The axial movement of the piston thus also plays an important role in starting up the print head after the process start, because the filling of the displacement body chamber and the nozzle hole, which in the case shown consists of an aluphobe material, is thus accelerated and favored. Material is expelled and the melt is thus forced into the outlet opening by a forward and backward movement of the actuator including the piston with a stroke of several millimeters, in particular at different speeds in the two directions of movement, preferably faster towards the outlet opening than away from the outlet opening, whereby material is released from the sleeve via the outlet opening. This promotes the wetting of the nozzle. After repeating this motion several times, the actuator is re-locked and the starting-up process continues.

In a further advantageous configuration of the method according to the invention, after a printing process in which the actuator is locked, a positive pressure is generated in the reservoir by means of which the melt is forced out of the outlet opening in order to empty the reservoir.

The actuator is released from the locking mechanism and moved axially during emptying of the piston in the displacement body chamber. This is an axial movement back and forth at a speed of 10-20 mm/sec, preferably 13-17 mm/sec, in particular 15 mm/sec for the movement of the end of the piston facing the outlet opening (piston tip) towards the outlet opening, as well as 2-7 mm/s, preferably 4-6 mm/sec., in particular 5 mm/sec for the movement of the end of the piston facing the outlet opening (piston tip) away from the outlet opening.

After emptying the reservoir, the piston is moved axially away from the outlet opening out of the displacement body chamber such that the piston has no contact with walls of the reservoir or the displacement body chamber so as not to adhere to the walls by the remaining melt. The actuator is then fixed by means of the locking element such that the piston remains in this position.

A further use of the axial movement enabled by the device according to the invention thus takes place upon emptying of the reservoir. In addition to a positive pressure in the reservoir, the piston is slowly moved back and forth in the displacement body chamber in order to accelerate the emptying and expel any residues from the reservoir. After the printing process (actuator clamped in position), a positive pressure is generated in the crucible that drives out the melt. It is conducive to release the actuator from the locking mechanism and slowly move the piston back and forth axially in the sleeve during the emptying with the aid of the additional axis. After completion of the emptying process, the piston is pulled out of the sleeve and clamped in a raised position, with the piston tip free-standing in the crucible, in order to prevent the piston from freezing.

The possibility of the piston being inserted and retracted also plays a decisive role during the printing process when exchanging the reservoir (crucible) and the piston for extending the service life of the components. This prolongs the availability of the system and thus allows for the printing of larger volumes.

Therefore, in a further advantageous configuration of the method according to the invention, when the reservoir is exchanged after the emptying of the reservoir, the reservoir is replaced with another reservoir. The newly introduced reservoir is brought to a temperature at which melt can be generated from a wire of the printing material, into which melt the piston attached to the actuator is submerged after release of the locking element. The speed of the submersion is selected so that adhesions to the piston are released and rise as a slag in the melt. The piston, which is thus freed of slag, is then axially brought with its tip axially into the displacement body chamber, and the actuator is fixed in this position by means of the locking element in order to begin the printing process or to continue it with the new reservoir.

When changing the crucible, the crucible/reservoir is thus first depleted as shown above. Subsequently, the old crucible can be removed and a new, clean crucible can be accommodated. Once the final temperature of the crucible has been reached, wire is fed in, and a melt pool is generated in which the soiled actuator is gradually submerged. By proceeding slowly, the adhesions on the actuator are released and rise up as slag. The actuator processed in this manner is retracted back into the sleeve (11) or the piston with its end facing the outlet opening into the displacement body chamber, and the starting up of the print head is performed again, if necessary. After a wetting of the outlet opening, the component production can be resumed.

In addition to the reservoir, the piston can also be exchanged. The procedure corresponds to the exchange of the reservoir, wherein however before introducing a new reservoir, the piston is released and replaced with a new piston.

A further possible use of axial movement and locking of the actuator at variable heights results in the production of droplets. It can be necessary for the stability of the droplet production to adjust the position and consequently the distance of the actuator tip to the outlet opening.

By means of the activation device, which is preferably configured as a clamping/release device, it is advantageously possible to position the actuator or the actuator module on a defined position before the start of printing and to release this position after printing and release the actuator for the retraction.

The clamping/release device advantageously permanently transmits a clamping force, which also fixes the housing of the actuator on a position during a lifting operation of the actuator punch.

The clamping energy required, for example in the form of a pneumatic pressure, is advantageously controllable by suitable valve blocks, in other configurations of the activation device by suitable control elements.

The melting region advantageously adjoins an inert atmosphere. This ensures that the pressure on the melt is nearly constant, so that it has no effect on the printing quality. Furthermore, the inert atmosphere ensures that no undesirable chemical reaction occurs in the reservoir. For example, the inert atmosphere can be formed from nitrogen or another inert gas.

The reservoir advantageously has the melting region for melting the metal, wherein the melting region adjoins the inert atmosphere, and additionally the displacement body chamber. This allows the melting operation to be separated spatially from the displacement or printing process, thereby improving the reproducibility of the droplets or of a component. The liquid phase of the metal present in the displacement body chamber can advantageously be caused to pass through the outlet opening by the displacement of the piston. The piston advantageously rests directly on the melt, whereby the accuracy of the printing increases further, because the melt is nearly incompressible. The melt or liquid phase of the metal passes from the melting region into the displacement body chamber either via heavy pressure or via a combination of the heavy pressure and the atmospheric pressure of the inert gas. The outlet opening corresponds to a nozzle and is exchangeable depending on the reservoir design.

The housing is advantageously formed in multiple parts, whereby a suitable temperature management and a permanent operation are ensured by the use of different materials. Due to the multi-part design, there is also a modular construction that allows for a needs-based exchange of the components. In addition, the print head is configured by the multi-part housing such that the different functions are also configured by different components.

Further measures improving the invention are described in greater detail below on the basis of the figures, together with the description of the preferred embodiment example of the invention.

### BRIEF DESCRIPTION OF THE DRAWINGS

The figures show:

FIG. 1 An example of a print head from the prior art; and

FIG. 2 an embodiment example of a print head according to the invention.

### DETAILED DESCRIPTION

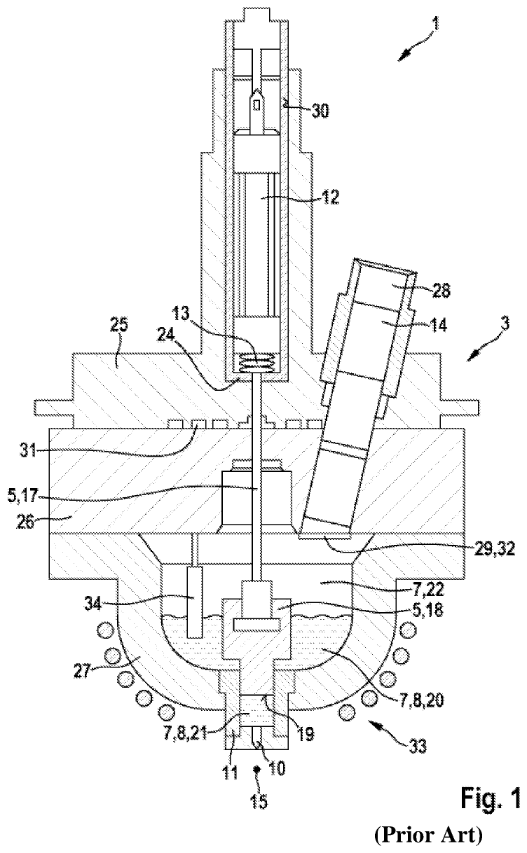

FIG. 1 shows an example of a known print head 1 for a 3D printer, in particular a metal printer.

The print head 1 comprises a housing 3, a device 28 for feeding a metal 14 in a solid phase, a piston 5, a reservoir 7, 27 having an outlet opening 10, and an actuator device 12 for displacing the piston. The reservoir 7, 27 has a melting region 20 and a positive displacement body chamber 21 for a liquid phase 8 of the metal 14, wherein the melting region 20 adjoins an inert atmosphere 22 and is connected to the positive displacement body chamber 21 such that the displacement of the piston 5 causes the liquid phase 8 of the metal 14 to pass through the outlet opening 10. The liquid phase 8 of the metal 14 is also referred to as melt 8, and the inert atmosphere 22 is formed by introduction of an inert gas 22 into the reservoir 7, 27. The introduction of the inert gas 22 preferably takes place via a cold region of the print head 1 into the reservoir 7, 27.

The housing 3 is formed in multiple parts, wherein it comprises at least one cooling flange 25, an insulating plate 26, and the reservoir 7, 27.

The piston 5 is formed in multiple parts, wherein it comprises at least one piston rod 17 made of a metallic material and a ceramic punch 18. In an alternative design, however, the piston 5 can also be formed in one piece, preferably of ceramic material. Starting from the actuator device 12, the piston rod 17 projects through the cooling flange 25 and the insulating plate 26 and into the reservoir 7, 27, where it transitions into the punch 18.

The cooling flange 25 has a recess 30 for receiving the actuator device 12, which is configured as a piezoelectric actuator 12. During operation, the piezoelectric actuator 12 is fixed in the recess 30 such that it applies a working stroke to the piston 5, specifically to the piston rod 17 of the piston, when a stress is applied. The piston rod 17 transfers the working stroke to the punch 18 so that it causes the liquid phase 8 of the metal 14 to pass through the outlet opening 10. The piston 5 can be reset into a home position without actuation of the actuator 12 by a spring 13, wherein the spring 13 is arranged in the recess 30 of the cooling flange 25 between a shoulder 24 and the actuator 12. The spring 13 is configured as a poppet spring.

Furthermore, the cooling flange 25 comprises cooling channels 31 for cooling. The cooling channels 31 are arranged between the cooling flange 25 and the insulating plate 26 and are flushed with a cooling medium. This serves as a cooling against heating by the melt 8 and for cooling actuator 12 in operation. The cooling flange 25 is formed from a metallic material.

The insulating plate 26 abutting the cooling flange 25 on sides of the cooling channels 31 is formed from a heat-insulating material and is configured so as to reduce a heat transfer from the reservoir 7, 27 to the cooling flange 25.

The device 28 for feeding the metal 14 opens into the reservoir 7, 27 and is arranged in the cooling flange 25 and the insulating plate 26. The device 28 projects through the cooling flange 25 and the insulating plate 26 and the metal 14, or the material 14 to be printed is feedable from the outside through the device 28. Preferably, pre-dosed pieces of material, or pellets, can be used. At the transition of the insulating plate 26 to the reservoir 7, 27, there is an opening 29 through which the material 14 passes into the reservoir 7, 27. The opening 29 is closable by a device 32, so that it is preferably only opened when the material 14 is fed in, thereby reducing the radiation energy from the reservoir 7, 27 to the device 28 for feeding the metal 14.

The reservoir 7, 27 is configured as a melting crucible 27, wherein an inductor 33 is arranged outside the melting crucible 27, and a sensor 34, in particular a temperature sensor, is arranged within the melting crucible. An insulator, not shown, can optionally be located between the melting crucible 27 and the inductor 33 or the inductor coil 33.

In a solid phase 14, the metal 14 reaches the melting region 20 of the melting crucible and is heated by the inductor 33 until it transitions into a liquid phase 8. Upon reaching a desired process temperature of the melt 8 determined by the temperature sensor 34, the print head 1 can commence operation. The liquid phase 8 or melt 8 passes by the punch 18 into the displacement body chamber 21 due to heavy pressure of the melt 8 or through a combination of heavy pressure and atmospheric pressure of inert gas 22. The punch 18 of the piston 5 is surrounded with a printing side 19 in the melt 8 or by melt 8 and is surrounded on the connecting side to the piston rod 17 in the inert atmosphere 22 or by the inert atmosphere 22. As a result of the process, the piston rod 17 does not come into contact with the melt 8.

Advantageously, the ceramic of the punch 18 is very well temperature-conductive in order to be able to transfer the heat generated by the inductor 33 well into the displacement body chamber 21.

When the piezoelectric actuator 12 is actuated, the printing side 19 of the punch 18 applies pressure to the melt 8 in the displacement body chamber 21 towards the outlet opening 10 and provides for the expelling of a droplet 15 through the outlet opening 10 of the reservoir 7, 27, and the displacement body chamber 21. The outlet opening 10 is configured so as to expel droplets 15 of the liquid phase 8 of the metal 14, wherein the outlet opening 10 is in the form of a nozzle 10 and can be fixedly connected to the melting crucible 27 or, as shown in the embodiment example, comprises a replaceable insert 11 that allows the use of different nozzle geometries. This replaceable insert 11 is also used as sleeve 11 or guide sleeve 11 of the piston.

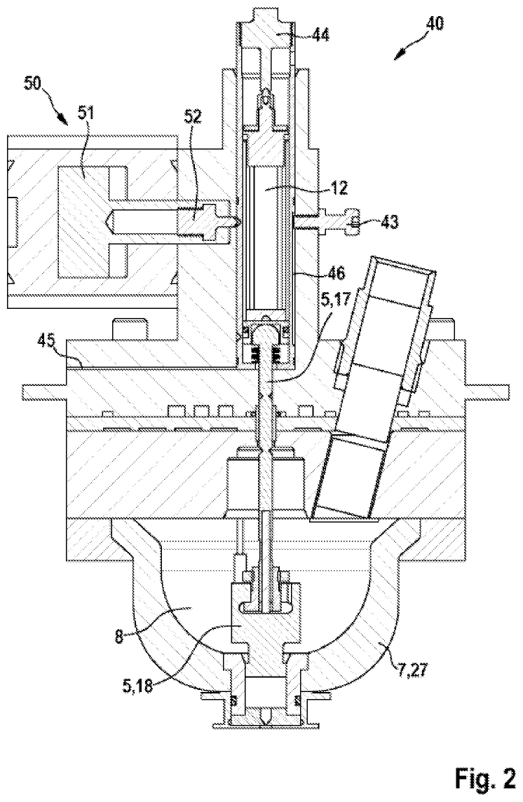

FIG. 2 shows a first embodiment example of a print head 1 according to the invention, wherein the print head 1 comprises a displacement unit 40 for inserting and retracting the piston 5 in and out of the reservoir 7, 27, and the displacement unit 40 is designed in a pressure-controlled manner.

The displacement unit 40 comprises an activation device 51 having a latching mechanism 52, a pin 43, and a compressed air connection 45. The actuator 12 is arranged between a piston module 44 and piston 5 or the piston rod 17.

Further, the displacement unit 40 comprises a locking element 50, wherein the locking element 50 comprises an activation device 51 having a latching mechanism 52. The activation device 51 is preferably pneumatically configured as in the embodiment example. However, in alternative configurations, the activation device can also be mechanically, hydraulically, electrically, or electromagnetically configured.

In operation, droplets 15 are pressed by the actuator 12, which has a positive pressure in the displacement body chamber 21 or compression chamber 21, through the outlet opening 10 or nozzle 10. In this case, a high surface tension of the liquid metal 8 or the molten metal 8 must be overcome. The displacement of the molten metal 8 in the direction of the reservoir 27 or the molten crucible is to be evaluated as a loss, so that a ring gap between the punch 18 and the sleeve 11 must be designed such that the portion of the melt displaced by the ring gap 8 from the total value of the volume displaced by an actuator stroke is minimal.

If the piston 5 remains in this narrow ring gap during solidification and melting, the material 8 expands greatly in the region where the gap is large and less so in the regions where the gap is narrow. This results in uneven stresses, which can lead to breakage. For this reason, it is beneficial to convey the piston 5 or the punch 18 out of the melt 8 after the printing process has been ended. However, as described above, the movement of the piston 5 can also occur and be necessary for other reasons.

In order for the actuator 12, or the actuator module, to be placed and fixed again at its defined position after the metal 8 has been remolten and before the start of the printing process, a suitable clamping/release device 50 is necessary, as shown in FIG. 2.

During the printing operation, the activation device 51, which in the embodiment example is configured as a pneumatic cylinder, transmits a force to the latching mechanism 52, which is configured as a fixation pin, which positions and fixes a housing and/or a sleeve of the actuator module 12. This force must be sufficiently large so that the actuator module 12 does not move during operation, even at high actuation forces, and does not attenuate the predetermined stroke of the piston 5. Upon completion of the printing process, the pneumatic cylinder 52 is retracted and releases the actuator module 12 for retraction from the molten metal 8.

If the punch 18 is to be retracted from the reservoir 7, 27 in order to allow for the described advantages of idling and extending before solidification of the melt 8, the piston 5 is raised. For this purpose, the latching mechanism 52 is released or retracted. Subsequently, by generating a positive pressure through the compressed air connection 45, the punch 18 is pushed upwards at a point below the actuator 12. The path of the piston 5 is limited by the pin 43, which can move within a groove 46 of the piston module 44. This prevents the piston 5 from being moved out of the housing 3 and thereby ensures the correct position for the latch 52. The retraction of the piston module 44 occurs in reverse order. The pin 43, or fixation pin, is retracted. Then, the piston module 44 is retracted, which can be accomplished in a variety of ways, such as by hand, by gravity, or by a spring at the upper position of the piston module 44. In this embodiment, the retraction is achieved by generating a negative pressure below the actuator 12.

Another option not described herein is to attach the actuator to an additional axis of movement/an additional actuator, e.g., a linear drive, which can be used in order to selectively approach different positions. The actuator can thereby be locked in different positions so that a displacement unit with a locking element in the sense of the present invention is also formed by this configuration.

1. A print head (1) for a 3D printer, comprising a housing (3), a device (28) for feeding a metal (14), a piston (5), a reservoir (7, 27) with an outlet opening (10), and an actuator device (12) for displacing the piston (5), wherein the reservoir (7, 27) has a melting region (20) and a displacement body chamber (21) for a liquid phase (8) of the metal (14), wherein the melting region (20) adjoins an inert atmosphere (22) and is connected to the displacement body chamber (21) such that, as a result of the displacement of the piston (5), the liquid phase (8) of the metal (14) can be caused to pass through the outlet opening (10), said housing (3) having a multi-part design and comprising at least one cooling flange (25), an insulating plate (26), and the reservoir (7, 27),
wherein
the print head (1) comprises a displacement unit (40) for inserting the piston (5) into the reservoir (7, 27) and retracting the piston (5) therefrom, the displacement unit (40) comprising a locking element (50).

2. The print head (1) according to claim 1,
wherein
the locking element (50) comprises an activation device (51) having a latching mechanism (52).

3. The print head (1) according to claim 1,
wherein
the activation device (51) has a pneumatic design.

4. The print head (1) according to claim 1,
wherein
a final shape between the activation device (51) and a sleeve surrounding the actuator device (12) is configured in a force-fit and/or form-fit manner.

5. A method for operating and/or starting up a print head (1) according to claim 1.

6. The method according to claim 5,
wherein, after a filling of the reservoir (7, 27) with liquid phase (8) of the metal (14), the locking element (50) is first released and the actuator device (12) is moved axially, wherein movement of an end of the piston (5) facing the outlet opening (10) in a direction of movement away from the outlet opening (10) is slower than movement of the end of the piston (5) facing the outlet opening (10) in a direction of movement towards the outlet opening (10),
and wherein, after a plurality of repetitions of the movements to promote a wetting of the outlet opening (10) with liquid phase (8) of the metal (14), the actuator device (12) is again locked in an axial position by the locking element (50).

7. The method according to claim 5,
wherein, after a printing process in which the actuator device (12) is locked, a positive pressure is generated in the reservoir (7, 27) and pushed out of the outlet opening (10) by the liquid phase (8) of the metal (14) in order to empty the reservoir (7, 27),
wherein the actuator device (12) is released from the locking mechanism and, during the emptying of the reservoir (7, 27), is moved axially with the piston (5) in the displacement body chamber (21) in a movement of an end of the piston facing the outlet opening towards the outlet opening and away from the outlet opening, said movement repeatedly changing direction,
and wherein, after the emptying of the reservoir (7, 27), the piston (5) is moved away from the outlet opening (10) out of the displacement body chamber (21) such that the piston (5) does not have any contact with walls of the reservoir (7, 27) or the displacement body chamber (21) so as not to adhere to the walls due to a remaining liquid phase (8) of the metal (14), and the actuator device (12) is fixed by the locking element (50) such that the piston (5) remains in this position.

8. The method according to claim 5,
wherein, upon an exchange of the reservoir (7, 27) after emptying of the reservoir (7, 27), a newly introduced reservoir (7, 27) is brought to a temperature at which liquid phase (8) of the metal (14) can be generated from a wire of the printing material, into which liquid phase the piston (5) attached to the actuator device (12) is submerged after release of the locking element (50),
wherein a speed of the submersion is selected such that adhesions on the piston (5) are released and rise as a slag in the liquid phase (8) of the metal (14), and after which the piston (5) freed from slag in brought axially into the displacement body chamber (21) with its end facing the outlet opening (10) and the actuator device (12) is fixed in this position by the locking element (50) in order begin the printing operation.

9. The print head (1) according to claim 1, wherein the 3D printer is a metal printer.
